(19) United States
(12) Patent Application Publication
(10) Pub. No.: US 2007/0247307 A1
(43) Pub. Date: Oct. 25, 2007

(54) Child tracking device

(76) Inventor: Theresa M. Riep, Scottsdale, AZ (US)

Correspondence Address: QUARLES & BRADY LLP, RENAISSANCE ONE, TWO NORTH CENTRAL AVENUE, PHOENIX, AZ, 85004-2391, US

(21) Appl. No.: 11/411,354

(22) Filed: Apr. 25, 2006

(51) Int. Cl. G08B 1/08

(52) U.S. Cl. 340/539.13

(57) ABSTRACT

A child tracking device includes a transmitting device and an adhesive bandage. The transmitting device is integrated into the adhesive bandage. A child tracking system includes a transmitting device integrated into an adhesive bandage and a portable receiver device. A child monitoring device includes a transmitting device and a flexible adhesive strip. The transmitting device is coupled to a portion of the flexible adhesive strip. A method of manufacturing a tracking device includes providing a transmitting device and providing a flexible adhesive strip. Again, the transmitting device is coupled to a portion of the flexible adhesive strip.

### FIELD OF THE INVENTION

The present invention relates in general to tracking devices and systems and, more particularly, to an apparatus, system and method of locating and tracking the movement of a wearer.

### BACKGROUND OF THE INVENTION

In today's increasingly mobile society, it is desirable to monitor the particular location and movement of humans, particularly children. Many children, especially young children, lack the understanding necessary to orient themselves and communicate sufficiently to find loved ones in the event that the child becomes lost. Additionally, a lone child easily becomes a potential kidnap target.

In addition to locating and tracking a wearer, it has become increasingly desirable for persons to be identified who are experiencing distress. For example, in many areas of the country, children become drowning victims when they fall into a swimming pool or similar body of water and are unable to swim or otherwise rescue themselves.

Several types of locator devices are known in the art. The locator devices use various technologies, such as radio frequency, Global Positioning Systems (GPS) and the like to provide the location and tracking function. These devices have generally been large, consume large quantities of power, are costly, and are easily removable by a wearer.

A need exists for a location and tracking device which is inexpensive and consumes low amounts of power. Additionally, a need exists for a device which is concealable and otherwise difficult to remove by a wearer. Finally, a need exists for a device with improved functionality to identify a wearer who experiences distress.

### SUMMARY OF THE INVENTION

In one embodiment, the present invention is a tracking device, comprising a transmitting device, and an adhesive bandage, wherein the transmitting device is integrated into the adhesive bandage.

In another embodiment, the present invention is a child tracking system, comprising a transmitting device integrated into an adhesive bandage, and a portable receiver device which receives a signal from the transmitting device.

In yet another embodiment, the present invention is a child monitoring device, comprising a transmitting device configurable to couple to a portion of a flexible adhesive strip.

In still another embodiment, the present invention is a method of manufacturing a tracking device, comprising providing a transmitting device, and providing a flexible adhesive strip, wherein the transmitting device is integrated into the flexible adhesive strip.

### BRIEF DESCRIPTION OF THE DRAWINGS

FIG. 1 illustrates an example operation of a child tracking device;

FIG. 2 illustrates a transmitter device;

FIG. 3 illustrates an additional example operation of a child tracking device including a global positioning system (GPS) operation;

FIG. 4 illustrates a child tracking device worn by a child;

FIG. 4a illustrates a cut-out diagram of a child tracking device as worn by a child; and

FIG. 5 illustrates an example operation of a water sensor integrated into a transmitting device of a child tracking device.

### DETAILED DESCRIPTION OF THE DRAWINGS

The present invention is described in one or more embodiments in the following description with reference to the Figures, in which like numerals represent the same or similar elements. While the invention is described in terms of the best mode for achieving the invention's objectives, it will be appreciated by those skilled in the art that it is intended to cover alternatives, modifications, and equivalents as may be included within the spirit and scope of the invention as defined by the appended claims and their equivalents as supported by the following disclosure and drawings.

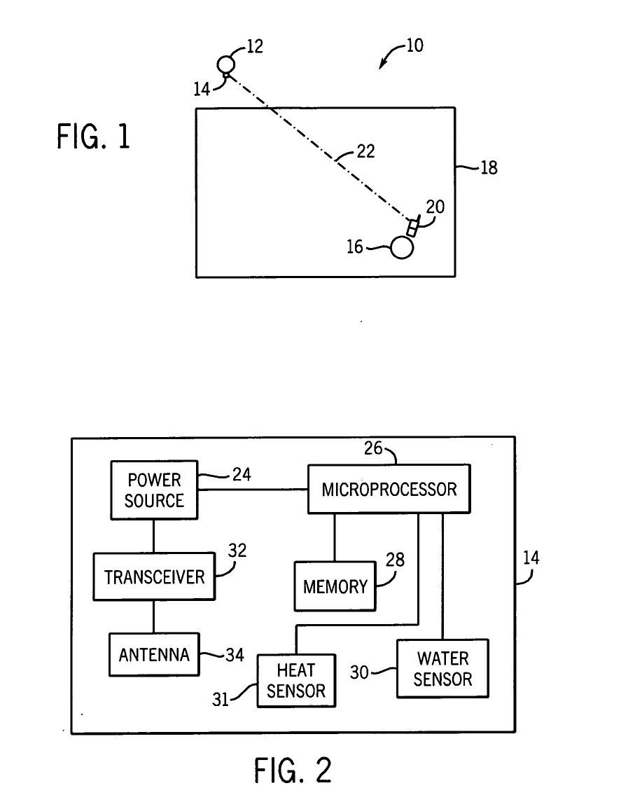

Turning to FIG. 1, an example operation 10 of a child tracking device as worn by a child 12 is depicted. Transmitter device 14 is intended to be a small, wearable device which can be placed underneath clothing so as to make the transmitter device 14 concealed and unnoticeable to a stranger to the child 12 who would easily remove the device 14. Alternatively, device 14 can be incorporated into a device such as a wristwatch or bracelet. Device 14 can be made to look like wearable jewelry and integrated into such items as charm bracelets, charm necklaces, or earrings.

An adult 16 is located in the interior of a building 18. Any conventional means for transmitting a tracking signal can be used by transmitter device 14. For example, transmitter device 14 can include a low-power radio frequency (RF) transmitter which is compatible with an IEEE 802.11(abg) specification. Transmitter device 14 can include a transceiver compatible with various cellular specifications such as code division multiple access (CDMA) or global system for mobile (GSM) protocols. Device 14 can include such features as programmable frequency, a modulated or unmodulated output frequency, and programmable output power. Device 14 can be designed to be in compliance with U.S. Federal Communications Commission (FCC) regulations for unlicensed operators. Device 14 can use short-range radio links in the 2.4 GHz Instrumentation Scientific and Medical (ISM) “free band,” commonly referred to as “Bluetooth,” to send and receive information. Use of Bluetooth or similar technology can allow device 14 to implement low-cost, low-power transceiver microchips.

As shown in FIG. 1, an adult 16 tracks the status of child 12 using a portable cellular phone 20. Transmitter device 14 sends a conventional tracking signal via radio frequency 22 to phone 20. A transceiver or receiver device can be integrated into phone 20 which sends and receives or receives data from device 14, and thereby displays the tracking information on phone 20.

The receiver device in phone 20 can include existing transceiver components in phone 20 which have been modified to accept radio frequency 22, whether the frequency 22 is proprietary or otherwise. The receiver device can be incorporated into a phone 20, as previously discussed, a personal desktop assistant (PDA) 20, or laptop or mobile personal computer device 20. The receiver device 20 can include a hand-held standalone product intended to be used with transmitter 14, forming a child tracking system.

Receiver device 20 can be incorporated into a portable music player device, such as an MP3 player or an equivalent. Software operating on the MP3 player can utilize the microprocessor and other electronic subcomponents of the MP3 player to perform operational functions to appropriately process received location information from device 14 and display the information. Similarly, device 20 can be intended to integrate into a hand-held portable radio device, or any combination of the previous portable devices.

In addition to device 14, receiver 20 can be designed to be compatible with any one of the aforementioned radio frequency technologies, such as Bluetooth or an 802.11(abg)_specification. Receiver 20 can include components which can receive and transmit information to more than one device 14.

Device 14 can continually transmit RF waves to device 20 as child 12 moves in a predetermined range. Receiver 20 can continually update a coordinate location of the child 12 and display the coordinate location of the child 12 on a graphical user interface (GUI) located as part of device 20. When the child 12 goes outside of the predetermined range, device 14 can transmit an alert signal to device 20. Alternatively, device 20 can utilize onboard electrical components to determine that the child 12 is outside of the range and provide the alert notification independently.

Devices 14, 20 can incorporate as sophisticated technologies as constraints such as size, weight, power consumption and cost will allow. In some cases, cost, size, weight, power consumption requirements and the like will dictate that device 14 consist of a basic, low-power RF transmitter device for a particular application. As technologies continue to mature and miniaturize, however, additional functionality and sophistication can be incorporated into devices 14, 20 as would be apparent to one ordinarily skilled in the art.

Turning to FIG. 2, an example transmitter device 14 is shown. Device 14 includes power source 24. Power source 24 can include such common power source devices as lithium-ion (Li-ion) batteries or an equivalent. Power source 24 can be intended to have a certain fixed shelf and operating life. Power source 24 can be rechargeable. Power source 24 is coupled to microprocessor 26, which can include accompanying onboard memory 28 such as electrically-erasable programmable read only memory (EEPROM), flash memory, or an equivalent.

Microprocessor 26 or microcontroller 26 can control various operating parameters of device 14. For example, a transmitting device can come preprogrammed with a certain operational power. When power source 24 begins to provide a power level less than a preprogrammed level, microprocessor 26 can instruct device 14 to send a message to the receiver device 20 for the adult to replace or recharge the device 14.

Transceiver device 32 can be an RF-transmitting device having various electronic subcomponents, including an oscillator, modulator, and other circuits that produce an RF signal 22 often found in the ultra-high-frequency (UHF) range for such an application. Alternatively, transceiver 32 can be a transmitting and receiving device, including electronic subcomponents that receive and demodulate an RF signal 22, then modulate and transmit a new signal 22. Device 32 can include RF micro-transmitting devices coupled to microcontrollers operating as microprocessors 26. Again, device 32 can include any transmitting or transceiver device known in the art to provide an RF tracking signal 22.

Again, as previously described, device 32 can include subcomponents which are compatible with existing cellular telephone protocols, such as CDMA or an equivalent. Device 32 can include subcomponents capable of receiving global positioning system (GPS) signals in order to calculate a coordinate address and/or transmit the address to a receiving device 20.

Water sensor 30 can include various water-sensing devices known in the art by taking microprocessor 26 controlled capacitance measurements using an integrated probe. Heat sensor 31 can include various heat-sensing devices known in the art. Heat sensor 31 can detect rapid changes in temperature. Heat sensor 31 can also detect extreme heat. Heat sensor 31 can measure a surface temperature of device 14. Transceiver 32 is also shown connected to antenna 34. Antenna 34 can include any antenna known in the art to satisfy a particular application using device 14.

The various subcomponents of device 14, such as water sensor 30, heat sensor 31, antenna 34, transceiver 32, etc., can be located as part of a single microfabricated device. The various electronic subcomponents of device 14 can be integrated into a single microchip structure. Device 14 can be overmolded with a protective polymer or epoxy structure to protect device 14. Alternatively, the various subcomponents can be fabricated separately as needed, and again coated with an overmolded epoxy or similar material.

Similarly, power source 24 can be integrated into device 14, or can be fabricated separately and attach to device 14 via a miniplug or similar connector. Antenna 34 can be integrated throughout device 14, or can be integrated throughout an adhesive strip, as will be further described. Device 14 can include such mechanisms as a light-emitting diode (LED) or similar to indicate that the device is on and functioning properly.

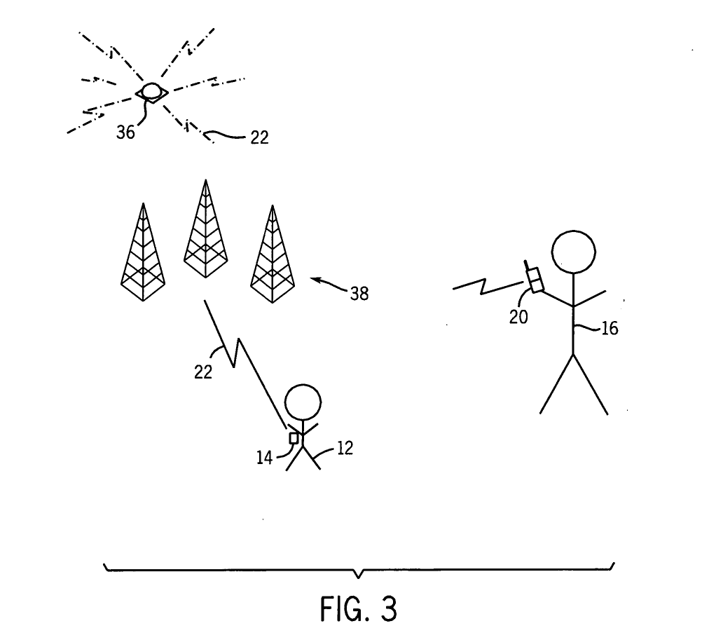

Turning to FIG. 3, an example operation of a child tracking device is depicted. A child 12 is shown wearing device 14. Device 14 sends a radio frequency 22 tracking signal to radio transmission/reception towers 23. Alternatively, radio frequency 22 is sent directly to portable phone 20 or other receiver device 20. As an additional alternative, device 14 receives global positioning system (GPS) RF 22 data from satellite 36. Based on the GPS data, device 14 computes a physical location and transmits location data via radio frequency 22 to phone 20. Additionally, phone 20 receives GPS RF 22 data from satellite 36 and computes the coordinate location of phone 20 vis-a-vis device 14.

A typical child-tracking scenario may occur as follows: A child 12 may wander beyond a predetermined range from receiver device integrated into phone 20. Phone 20 continuously determines the proximity of child 12 based on received radio frequency 22 information. Phone 20 next makes a determination that the child 12 has exceeded the predetermined range and provides a notification signal and/or visual alert to an adult 16. The notification signal can be preprogrammed to be a unique tone based on different scenarios. For example, if the child 12 has simply wandered beyond a particular range, the tone can include a soft warning bell that repeats at various intervals until the notification is turned off. However, if the phone 20 determines that the child is in distress, such as an indication from device 14 that the water sensor 30 has identified water in close proximity to the device 14, the phone 20 can sound a high-volume alarm tone to alert the adult 16 that a more serious situation needs to be addressed.

A graphical-user-interface (GUI) integrated into phone 20 can plot the location of a child 12 wearing device 14. Each device 14 can be assigned a unique color code or number code. An adult 16 can monitor several children 12 having unique color codes or number codes associated with the child 12 in the same designated range.

If a child 12 exceeds operational range of the device 14, phone 20 can be programmed to display the last known location of the child 12 on a map of the designated range.

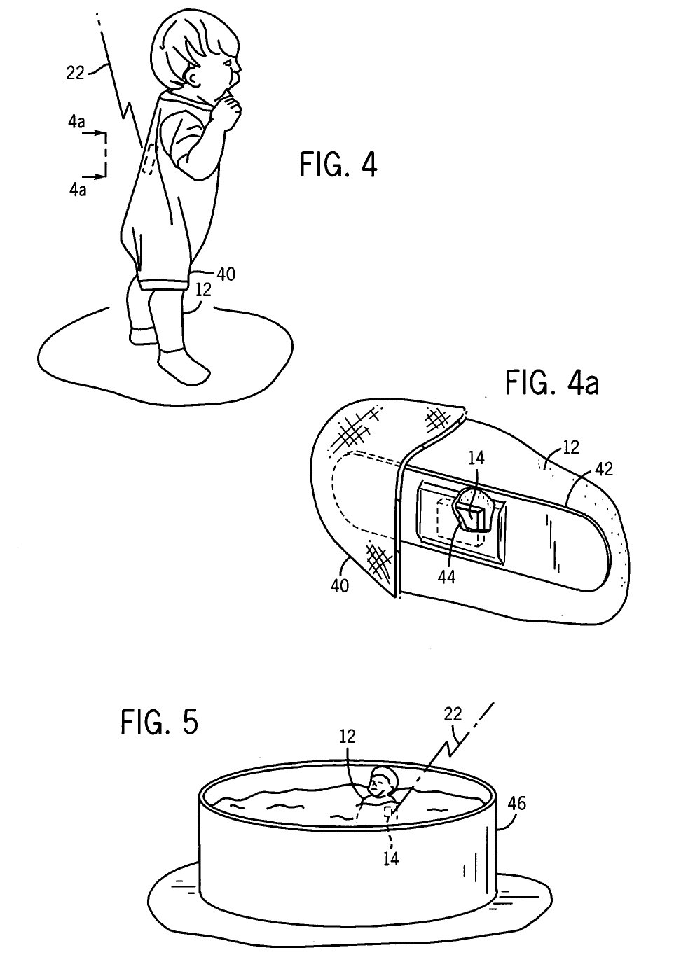

FIG. 4 illustrates a child 12 wearing device 14. Device 14 is located on the child's back, underneath clothing 40. Device 14 is small and concealable. A stranger to child 12 would not initially notice the device 14 as depicted. As such, device 14 can continue to function, transmitting RF signals in cases where a kidnapper would remove a conspicuous device, such as a bracelet or necklace-worn device. Device 14 emits RF signals 22 as depicted.

Turning to FIG. 4a, device 14 is illustrated in more detail as worn by a child 12 in a cut-out diagram. Here again, a layer of clothing 40 is shown. Device 14 is located as part of a sleeve 44, or padded enclosure 44, integrated into adhesive strip, bandage, or sticking plaster 42. Adhesive strip 42 can include a length of woven fabric or plastic material which is covered with a layer of adhesive, similar to a Band-Aid® brand adhesive bandage.

As previously mentioned, antenna 34 can be designed to be integrated throughout strip 42 to provide additional surface area and thereby promote an increased range of operation.

Sleeve 44 is large enough to enclose device 14 to protect device 14 as well as protect the skin of a child 12. Sleeve 44 can include a padding structure made from a fabric or polymer material to provide support, protection, and comfort as needed. Adhesive strip 42 can include a layer of commercial-strength adhesive intended to last for a period of several days, in similar fashion to plasters which are worn on the skin to administer medicines or other drugs in low doses over a longer period of time.

FIG. 5 illustrates a child 12 who has fallen into pool 46. The child 12 has activated water sensor 30 as located as part of device 14. Water sensor 30 triggers an alarm signal 22 which is sent to phone 20. Similarly, heat sensor 31 can trigger an alarm signal 22 which is sent to phone 20 when a large change in surface temperature is detected. Heat sensor 31 can work in conjunction with microprocessor 26 to send an alarm signal 22 to phone 20 when a surface temperature of the device 14 (and thereby, child 12) becomes higher than a preprogrammed level. The alert feature can be tailored to help the child 12 avoid too much exposure in bright sunlight, for example, and prevent sunburn.

While one or more embodiments of the present invention have been illustrated in detail, the skilled artisan will appreciate that modifications and adaptations to those embodiments may be made without departing from the scope of the present invention as set forth in the following claims.

What is claimed is:

1. A tracking device, comprising:
a transmitting device; and
an adhesive bandage, wherein the transmitting device is integrated into the adhesive bandage.

2. The tracking device of claim 1, further including a sleeve integrated into the adhesive bandage for receiving the transmitting device.

3. The tracking device of claim 1, wherein the transmitting device further includes a water or heat sensor for transmitting an alarm in the event of water or heat detection.

4. The tracking device of claim 1, further including an antenna integrated into the adhesive bandage for transmitting a radio frequency (RF) signal.

5. The tracking device of claim 1, wherein the transmitting device is compatible with a global positioning system (GPS) specification.

6. The tracking device of claim 1, further including a receiving device for receiving a signal from the transmitting device.

7. The tracking device of claim 6, wherein the receiving device is operable to integrate into a portable telephone, personal desktop assistant (PDA), portable music player, or portable radio.

8. A child tracking system, comprising:
a transmitting device integrated into an adhesive bandage; and
a portable receiver device which receives a signal from the transmitting device.

9. The system of claim 8, further including a sleeve integrated into the adhesive bandage for receiving the transmitting device.

10. The system of claim 8, wherein the transmitting device further includes a water or heat sensor for transmitting an alarm signal in the event of water or heat detection.

11. The system of claim 8, further including an antenna integrated into the adhesive bandage for transmitting the signal.

12. The system of claim 8, wherein the transmitting device is compatible with a global positioning system (GPS) specification.

13. The system of claim 8, wherein the portable receiver device is operable to integrate into a portable telephone, personal desktop assistant (PDA), portable music player, or portable radio.

14. A monitoring device, comprising:
a transmitting device configurable to couple to a portion of a flexible adhesive strip for attaching to skin.

15. The device of claim 14, wherein a sleeve integrated into the flexible adhesive strip receives the transmitting device.

16. The device of claim 14, wherein the transmitting device further includes a water or heat sensor for transmitting an alarm signal in the event of water or heat detection.

17. The device of claim 14, further including an antenna configurable to be integrated into the flexible adhesive strip for transmitting a radio frequency (RF) signal.

18. The device of claim 14, wherein the transmitting device is compatible with a global positioning system (GPS) specification.

19. The tracking device of claim 14, further including a receiving device operable to integrate into a portable telephone, personal desktop assistant (PDA), portable music player, or portable radio for receiving a signal from the transmitting device.

20. A method of manufacturing a tracking device, comprising:
providing a transmitting device; and
providing a flexible adhesive strip, wherein the transmitting device is coupled to a portion of the flexible adhesive strip.

21. The method of claim 20, further including providing a sleeve integrated into the flexible adhesive strip for receiving the transmitting device.

22. The method of claim 20, further including providing a water or heat sensor integrated into the transmitting device for transmitting an alarm in the event of water or heat detection.

23. The tracking device of claim 20, wherein the transmitting device is compatible with a global positioning system (GPS) specification.

24. The method of claim 20, further including providing an antenna integrated into the flexible adhesive strip for transmitting a radio frequency (RF) signal.
